(19) United States
(12) Patent Application Publication
(10) Pub. No.: US 2018/0126388 A1
(43) Pub. Date: May 10, 2018

(54) Comminution Plant with a Comminution Machine

(71) Applicant: TAKRAF GmbH, Leipzig (DE)

(72) Inventors: Patrick Neufeldt, Finsterwalde (DE); Steffen Nowak, Sallgast (DE); Martin Nitzschner, Dresden (DE)

(21) Appl. No.: 15/786,613

(22) Filed: Oct. 18, 2017

(30) Foreign Application Priority Data
Nov. 4, 2016 (DE) 102016221663.5

(51) Int. Cl. B02C 23/00; B66F 3/24; B66F 3/36

(52) U.S. Cl. CPC B02C 23/00; B66F 3/36; B66F 3/24

(57) ABSTRACT

A comminuting plant with a comminuting machine for reducing the grain size of a mineral substance, the comminuting machine having a machine housing and at least one displacement apparatus, the machine housing having at least one housing wall with reinforcing ribs, and the displacement apparatus being fastened to the housing wall and being movable into a displacement position, in which the comminuting machine can be displaced, standing on a support element of the displacement apparatus, and into a standing position, in which the comminuting machine stands in a stationary manner. The object of the invention is to provide a comminuting plant with compact displacement apparatus which can be displaced with short maintenance times. This is achieved in that the housing wall has at least one cut-out formed for the installation of the displacement apparatus so that the displacement apparatus can be integrated at least largely into the housing wall.

### CROSS REFERENCE TO RELATED APPLICATIONS

This application claims the priority of DE 102016221663.5 filed on 2016 Nov. 4; this application is incorporated by reference herein in its entirety.

### BACKGROUND

The present invention relates to a comminuting plant with a comminuting machine, in particular a crushing plant with a crushing machine or a sizer for reducing the grain size of a mineral substance, the comminuting machine having a machine housing and at least one displacement apparatus, the machine housing having at least one housing wall with reinforcing ribs, which extend over at least some of the width of the housing wall, or in the form of a slab, and the displacement apparatus being fastened to the housing wall and being movable into a displacement position, in which the comminuting machine can be displaced, standing on a support element of the displacement apparatus, and into a standing position, in which the comminuting machine stands in a stationary manner.

Comminuting plants are used in the fields of mining and metallurgy to set grain sizes of a mineral substance to a desired grain size by means of the comminuting machine. The mineral substance can be, for example, a rock, an ore, cement or another material. Examples of comminuting machines are crushers, sizers and roller presses. A subtype of crusher for producing gravel-like bulk materials is a roller crusher. Comminuting plants for fine comminution or pulverising are roller presses and mills, for example. In comminuting plants, raw materials are comminuted in bulk. These plants regularly have comminution outputs of many tons per hour. The plants are designed to be appropriately large and stable. In addition to the comminuting machine as the central component, the comminuting plant comprises further components, for example a load-bearing structure on which the comminuting plant stands and can be displaced. Within a machine housing, comminuting tools such as crushing rollers are moved to crush and comminute the processed mineral substance. In the process, enormous forces and pressures act on the machine housing and its walls. Consequently, the housing walls are not simple steel walls, but rather highly stable wall structures provided with a supporting structure of reinforcing ribs or massive walls such as 350 mm-thick steel slabs. The comminuting plants are classified as stationary, semi-mobile or fully mobile comminuting plants, depending on their structure and their mobility, for example in a progressing surface mine.

Inside the comminuting plant, it is sometimes necessary to move or displace the comminuting machine, for example for maintenance work. To this end, comminuting machines are known in the prior art with displacement apparatus or displacement units which have externally attached wheels and can be moved into a displacement position with the comminuting machine raised so that the comminuting machine standing on the displacement apparatus can be displaced. The displacement apparatus sometimes also have their own lifting apparatus, with which the comminuting machine can be raised.

The installation space or space requirement taken up by pre-assembled displacement apparatus can be disruptive in confined conditions. Comminuting plants are generally required to have the highest possible productive availability and short downtimes to ensure efficient operation of the comminuting plants and their operating environment. An occasional, laborious installation of displacement apparatus when the comminuting machine is converted or displaced can be associated with undesirable installation times and downtimes of the comminuting plant.

### SUMMARY

The present invention relates to a comminuting plant with a comminuting machine for reducing the grain size of a mineral substance, the comminuting machine having a machine housing and at least one displacement apparatus, the machine housing having at least one housing wall with reinforcing ribs, which extend over at least some of the width of the housing wall, or in the form of a slab, and the displacement apparatus being fastened to the housing wall and being movable into a displacement position, in which the comminuting machine can be displaced, standing on a support element of the displacement apparatus, and into a standing position, in which the comminuting machine stands in a stationary manner. The object of the invention is therefore to demonstrate a comminuting plant having a compact displacement apparatus which can be displaced within short maintenance times. The object is achieved in that the housing wall has at least one cut-out formed for the installation of the displacement apparatus so that the displacement apparatus can be integrated at least largely into the housing wall, within the width thereof, by being arrangeable at least partially in the cut-out.

### DETAILED DESCRIPTION

The object of the present invention is therefore to demonstrate a comminuting machine having a compact displacement apparatus which can be displaced within short maintenance times.

The object of the invention is achieved by a comminuting plant with a comminuting machine having the features indicated above, at least one of the housing walls of which has at least one cut-out formed for the installation of at least one displacement apparatus so that the at least one displacement apparatus can be integrated at least largely into the housing wall, within the width thereof, by being arrangeable at least partially in the cut-out.

The at least one cut-out is included as standard in at least one of the housing wall of the machine housing of the comminuting machine according to the invention. The at least one displacement apparatus can be installed permanently but can also be installed temporarily only for maintenance, for example, or integrated in the comminuting machine.

Said cut-out can be produced by milling a slab. A slab is a plate that is solid over the width thereof. In an assembled housing wall with reinforcing ribs, the cut-out can extend through the reinforcing ribs and through cavities between the reinforcing ribs. The integration of the at least one displacement apparatus in the at least one housing wall is by no means trivial but must be thoroughly planned and taken into account in the design of the housing wall. Despite the cut-out present, a housing wall of undiminished stability can still be designed by means of other arrangements and additions of design elements or reinforcing ribs within the housing wall. The integration of the displacement apparatus into the housing wall frees up installation space which would be occupied with a conventional displacement apparatus. In the solution according to the invention, the at least one displacement apparatus can be arranged close to the centre of gravity of the comminuting machine, thanks to its integratable design. In this connection, direct application of force into the housing wall is possible, and therefore the advantages of the comminuting plant with a comminuting machine according to the invention are not limited to its compactness but go further, including for example excellent mechanical reliability in the spatial environment of the at least one displacement apparatus.

In its standing position, the comminuting machine stands on a subsurface, for example a solid load-bearing structure or ground. When the comminuting machine is used as intended in the standing position, a mineral substance, for example a rock or an ore required in mining, is conveyed continuously into the comminuting machine and comminuted, for example crushed, to a desired end product size by means of comminution tools in the machine housing. In the standing position, the displacement apparatus has no function. However, it can be kept inside the housing wall of the comminuting machine for later use.

The displacement position of the comminuting machine is a position in which it can be moved or displaced from a first location to a second location. To this end, the comminuting machine no longer stands directly on the subsurface but on the at least one displacement apparatus therebetween and on the support element of the displacement apparatus. The support element is mounted in a support element guide so that the forces occurring during the displacement process are directed into the housing wall with the aid of the support element and the support element guide. The displacement apparatus can have at least one wheel as a component of the support element. Overall, a plurality of wheels, rollers, heavy-duty roller gear or sliding devices, for example four wheels, can be present for displacing the comminuting machine.

The at least one displacement apparatus can be integrated completely in the housing wall so that the housing wall has its usual width in the region of the displacement apparatus. In some embodiments of the comminuting plant according to the invention, the width of the housing wall is slightly larger in the region of the at least one displacement apparatus. In this case, the at least one displacement apparatus is partially or largely integrated in the housing wall, within the width or original wall thickness thereof. The machine housing and the housing walls thereof can have reinforcing ribs at regular intervals. The integration of the at least one displacement apparatus in the housing wall can involve the design feature that the displacement apparatus extends through at least one reinforcing rib, the reinforcing rib or the plurality of reinforcing ribs having corresponding openings or cut-outs for receiving the displacement apparatus.

The at least one displacement apparatus of the comminuting plant according to the invention can comprise a lifting apparatus, in particular a hydraulic cylinder, with which the displacement apparatus and the support element thereof can be extended into the displacement position, and at least portions of the comminuting machine can be lifted out. A joint, for example a ball joint head, can be arranged between the hydraulic cylinder and the support element. The hydraulic pump necessary for actuating the hydraulic cylinder can be provided temporarily as a separate, manually operated or motorised hydraulic module, with which two or four hydraulic cylinders can be driven at the same time, so that the comminuting machine can be lifted out in one step or several steps.

To displace the comminuting machine, it must be lifted off the subsurface and stood on the at least one displacement apparatus. Therefore, one task of the displacement apparatus consists in ensuring the necessary distance between the comminuting machine and its subsurface during displacement. The displacement apparatus can be an apparatus of variable length; the length of the displacement apparatus can be greater in the displacement position than in the standing position. In this case, the displacement apparatus is largely extended when in the displacement position. The maximum extension length of the displacement apparatus can be greater than required to set the displacement position.

The lifting apparatus can be part of the displacement apparatus, for example a hydraulic cylinder or an electromechanical drive. However, the displacement apparatus can also be a simpler mechanical apparatus, for example if an external apparatus, for example a crane, is used as the lifting apparatus, and an external aid, for example a trolley, is used for moving.

The displacement apparatus can have a pressure element and a pressure element introduction opening, the support element, the pressure element and the pressure element retainer being formed to support the displacement apparatus in relation to the housing wall during displacement of the comminuting machine and to absorb at least a portion of the weight of the comminuting machine.

The supporting of the weight of the comminuting machine is associated with a transmission of the supporting force into the housing wall, where the pressure resulting from the supporting force can be absorbed at the supporting point. A pressure element can be arranged at this point in the form of a structural element which can bear sufficient mechanical load so that there is no danger of damage to the pressure element during its use. The pressure element can be a pressure plate with extensive force application faces so that the pressure plate is deformed only elastically and not plastically. If a plurality of displacement apparatus are attached to the housing wall, the weight is distributed. The proportional weight which must be absorbed by an individual displacement apparatus decreases with the number of displacement apparatus present.

The displacement apparatus can have at least one wheel and at least one wheel retainer. The displacement apparatus can have exactly one wheel but it can also have a plurality of wheels, for example in a swing arm arrangement. The wheels can be equipped with a sliding bearing or with a roller bearing, for example. However, the displacement apparatus can also be designed without its own wheels, for example in the form of a purely mechanical support on a displacement trolley or heavy-duty roller gear. In this case, wheels, rollers or other means for reducing friction can be arranged in the displacement trolley or heavy-duty roller gear.

According to one embodiment of the invention, the displacement apparatus is designed for displacement on a rail and comprises at least one rail guide, the rail guide being designed to fit laterally over the rail. The rail guide can be in the form of a flange on one side of a wheel, a double wheel flange or a projection of a wheel retainer. Alternatively, the rail guide can be implemented by a bulge on the rail, said bulge acting as a lateral guide for the wheel or wheels. With rails, a displacement path can be predefined and easily controlled by means of the course of the rails. Rail guides can be used to specify and secure the position of the displacement apparatus with respect to the rails during the displacement process. In this case, the displacement apparatus can be rotatable about a substantially vertical axis, in particular by at least 90°; a displacement direction of the displacement apparatus can be defined by the rotation and, when the displacement direction has been defined, an angular position of the displacement apparatus can be set, preferably by means of a locking element. In this rotatable embodiment, the displacement apparatus can be used to move in several directions on the subsurface plane, for example in a direction along the housing wall in which the displacement apparatus is situated and in a direction transverse thereto, that is, rotated 90° to the housing wall. Angles other than 90° can also be provided, in adaptation to particular local conditions.

The comminuting plant according to the invention can have a load-bearing structure comprising rails, the comminuting machine being displaceable on the load-bearing structure. With the load-bearing structure, the comminuting machine can for example be arranged in the comminuting plant at such a height that a conveyor belt or a wagon can be arranged under the comminuting machine to receive the comminuted mineral substance. Furthermore, the comminuting plant can have a turntable which is rotatable about a pivot and has a rail segment situated thereon. The turntable can be understood as a type of switch allowing the selection of one of several displacement directions, the several directions being defined by rails laid in different directions. The positioning and mounting of the turntable can be implemented advantageously by including a pivot. A rail crossing can also be implemented differently, for example by means of fixed, intersecting rails which are interrupted in the environment of the intersection; the interruption regions can be filled with insertable rail segments.

The rail segment can have a greater width in a central region of the turntable than the rails next to the turntable and preferably have a recess for receiving a wheel. The greater width of the rail segment on the turntable improves the tolerance for error of the rail system. Even if there are small angle tolerances in the angular position of the turntable and/or of the displacement apparatus, no damage resulting from notch effects occurs when a wheel travels from the rail segment on the turntable onto an adjacent rail. The recess in the rail segment on the rotation point can ensure precise positioning of the wheel on the rotation point.

According to an advantageous embodiment, the displacement apparatus has a fork-like rail guide, which can fit over the rail segment on both sides, so that the rail segment can remain engaged in the rail guide when the displacement apparatus rotates. Thereby the turntable can be rotated in engagement with the displacement apparatus, coupled to rotatable components of the displacement apparatus. The fork-like rail guide with two lateral guide elements next to both sides of the rail is a universal guide with uses for different movements.

The invention also comprises combinations of features which are not explicitly described in combination with each other. Features listed successively should each be understood as separate features, not necessarily as a cohesive combination of features.

### BRIEF DESCRIPTION OF THE DRAWINGS

The present invention shall be explained in more detail below on the basis of drawings, in which

FIG. 1 shows a machine housing of a roller crusher,

FIG. 2 shows a displacement apparatus in the displacement position,

FIG. 3 shows the displacement apparatus in the standing position,

FIG. 4 shows the displacement apparatus during an angle-setting process,

FIG. 5 shows the displacement apparatus with a partially open housing wall, and

FIG. 6 shows the displacement apparatus with a partially open housing wall, in a displacement position.

### DETAILED DESCRIPTION OF THE PREFERRED EMBODIMENTS

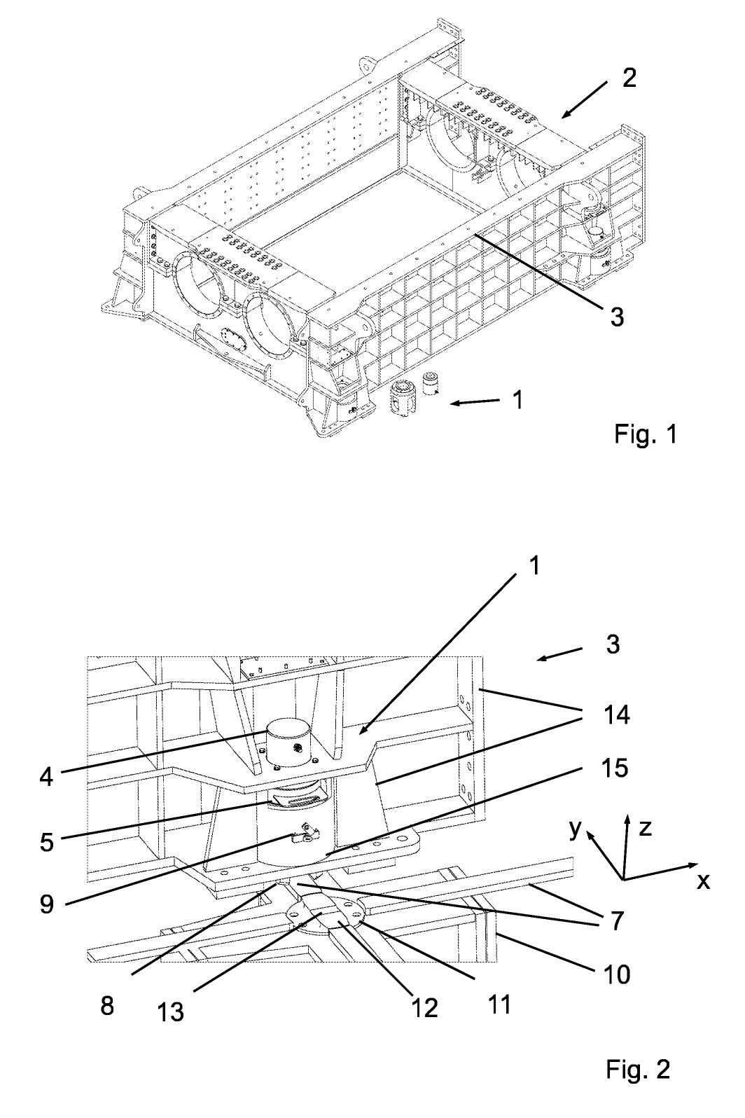

FIG. 1 shows a machine housing 2 of a roller crusher as an exemplary embodiment of a comminuting machine of a comminuting plant according to the invention. It can be seen that two displacement apparatus 1 can be arranged in the housing wall 3. The rear displacement apparatus is shown in the mounted state and the front displacement apparatus is shown as an exploded diagram in a dismantled state. Two further displacement apparatus are arranged on the opposite housing wall but are covered and therefore not visible in FIG. 1.

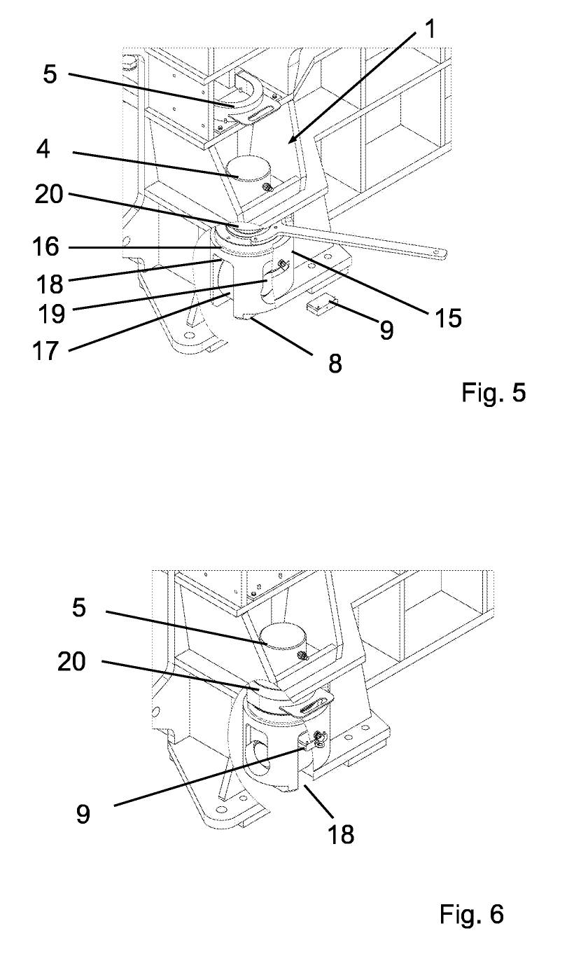

FIGS. 2-6 show details of the housing wall 3 of FIG. 1 in a region of the displacement apparatus 1 in the mounted state. The housing wall 3 is part of the machine housing and has a structure of reinforcing ribs 14. The reinforcing ribs 14 are welded to other steel plates for reinforcement and thus help to provide the necessary mechanical strength of the housing wall 3. In the example shown, the displacement apparatus 1 has a lifting apparatus, which is mainly the hydraulic cylinder 4. The lifting apparatus can push a support element 16, which can be seen in FIGS. 5 and 6, of the displacement apparatus 1 downwards out of the housing wall 3 and in the process lift the comminuting machine in the region of the displacement apparatus 1. In the exemplary embodiment shown, the use of the hydraulic cylinder 4 is intended only when the comminuting machine is stopped at a location, to push the support element 16 far enough away from the hydraulic cylinder 4 to open a pressure element introduction opening 6 for introducing or removing a pressure element 5. During a displacement process, however, the hydraulic cylinder 4 is preferably relieved and the load in the region of the displacement apparatus 1 is directed via the support element 16 and the pressure element 5 into the reinforcing rib 14 situated above the pressure element 5 or initially into a threaded ring 20 serving to fasten the hydraulic cylinder 4. The pressure element 5 directs the effective forces as a pressure plate over a large area into the housing wall 3 so that no stress peaks and damage can occur in this region during the process of displacing the comminuting machine. Below the pressure element 5, the design element of a wall or reinforcing rib 15 shaped as an open cylinder is shown, which acts as a support element guide for the cylindrical support element 16 behind it.

In the exemplary embodiment shown, the comminuting plant includes the load-bearing structure 10, a section of which is shown, the rails 7 being laid on the load-bearing structure 10 in two directions, specifically in an X direction and a Y direction. The comminuting machine can be displaced on its displacement apparatus 1 on the load-bearing structure 10 in a substantially horizontal plane. In the displacement position shown in FIG. 2, the support element 16 and the comminuting machine thereon stand on a wheel 17, which can be seen in FIGS. 5 and 6, and there is a possibility of displacement in the Y direction. Rail guides 8 are arranged axially next to the wheel 17 and fit over the rail 8 in a forked manner in FIG. 2, preventing movement in the X direction and only allowing movement in the Y direction. The cylindrical support element 16 of the displacement apparatus shown is rotatable about the Z axis and can be locked with a locking element 9 at two angles, specifically at 0° for displacement in the X direction and at 90° for movement in the Y direction. In the exemplary embodiment shown, the locking element 9 is a cuboid bar, which is secured in its inserted position against accidentally sliding out by means of the securing element, which can also be seen. The locking element 9 can be seen in its entirety in the pulled-out position in FIG. 4.

The load-bearing structure 10 has a turntable 11 with a rail segment 12 formed thereon, which is rotatable about the Z axis about a central, vertically oriented pivot. The turntable 11 can be locked either in the X orientation or in the Y orientation with the two visible bolts. In the middle of the rail segment 12 shown, there is a cylindrical recess 13, in which the wheel 17 is provided during simultaneous rotation of the turntable 11 and the support element 16.

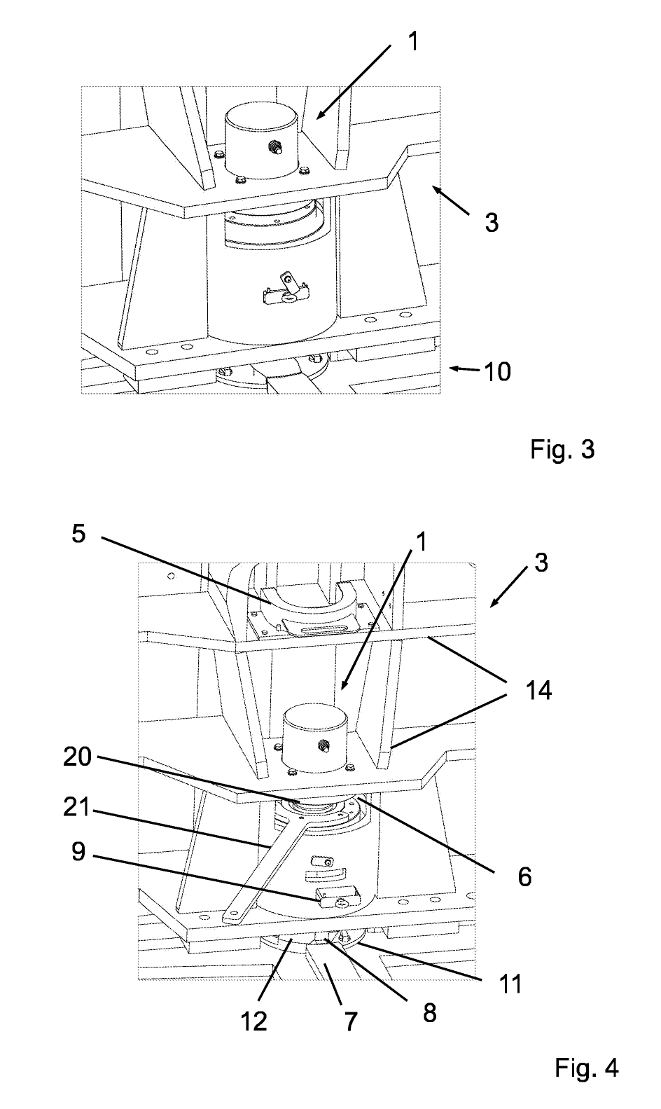

FIG. 3 shows a somewhat smaller detail of the displacement apparatus 1, in a standing position in which the pressure element 5 is kept fastened on its rest and the hydraulic cylinder 4 is retracted, so that the comminuting machine stands directly or indirectly on the load-bearing structure 10 and thus e.g. can be used productively to crush rock or can be maintained. In FIG. 4, a pressure element receiving opening 6 can be seen, since the pressure element 5 has been manually removed. Via the opening of the pressure element receiving opening 6 there is a view of the cylindrical support element 16, which has an annular collar at the top on which the pressure element 5 is placed. Here, the pressure element 5 has been taken out, stored and secured by means of screw-fastenings at a storage location inside the housing wall 3, as can be seen in FIG. 4. The inner raised cylindrical edge inside the annular collar serves as a stop for the horseshoe-shaped pressure element 5 when the latter is inserted into the pressure element receiving opening 6. The pressure element 5 has a retaining plate and a handle. In FIGS. 3 and 4, shims (not shown) are arranged between the load-bearing structure 10 and the housing wall 3, so that the weight of the comminuting machine acts on the shims and not on the displacement apparatus 1.

FIG. 4 shows the displacement apparatus 1 during conversion from the Y orientation of the cylindrical support element 16 as shown in FIGS. 2 and 6 to the X orientation shown in FIG. 5. In FIGS. 5 and 6, the housing wall 3 is shown partially open to allow a view of internal parts of the displacement apparatus 1. The cylindrical support element 16 is a perforated cylinder with a cuboid cut-out 18 for receiving the wheel 17. Owing to the cuboid cut-out 18, the support element in the exemplary embodiment shown has the form of a fork which, at the same time, acts as a guide for the wheel 17 and also forms the forked rail guide 8. In other exemplary embodiments which are not shown, the rail guide is implemented differently, for example by a double-flange on the wheel (17).

In the exemplary embodiment shown, the wheel 17 and the locking element 9 have substantially the same width as the cuboid cut-out 18, so that the cut-out 18 can be used as a guide for the wheel 17 during displacement and as a guide for the locking element 9 when the lifting apparatus is raised and lowered. A cylindrical and cuboid cut-out 19 in the support element 16 serves for the introduction of a wheel axis in its cylindrical part and as a guide groove for the locking element 9 in its cuboid part with height adjustment of the support element 16 and simultaneously locked angular position. In the depictions of FIGS. 4 and 5, the locking element 9 is outside its guide in the displacement apparatus 1, so that the cylindrical support element 16 can be rotated in its support element guide formed from reinforcing ribs 15 shaped as open cylinders. A key 21 which is used for manually performing this rotation and has pins for engagement in corresponding holes in the collar of the support element 16 is likewise shown. During this rotation, the forked rail guide 8 fits over the rail segment 12 of the turntable 11, so that the angle of the previously released turntable 11 is set at the same time as the angle of the displacement apparatus 1 and of the support element 16.

After rotation, the angular position of the support element 16 is locked with the locking element 9 and the angular position of the turntable 11 is locked with the bolt provided for this purpose. Thanks to its angular adjustability, the displacement apparatus 1 shown can be used universally and efficiently for movements both in the X direction and in the Y direction. Therefore, multi-stage displacement processes can be carried out quickly and safely in a sequence of different directions. The presented displacement apparatus thus helps to provide a high degree of availability of the comminuting plant according to the invention.

### LIST OF REFERENCE NUMERALS

1 Displacement apparatus of a comminuting machine

2 Machine housing

3 Housing wall

4 Hydraulic cylinder

5 Pressure element

6 Pressure element introduction opening

7 Rail

8 Rail guide

9 Locking element

10 Load-bearing structure

11 Turntable

12 Rail segment on turntable

13 Recess

14 Reinforcing ribs

15 Reinforcing rib shaped as hollow cylinder

16 Support element

17 Wheel

18 Cuboid cut-out

19 Cylindrical and cuboid cut-out

20 Threaded ring

21 Key

1. A comminuting plant with a comminuting machine, in particular a crushing plant with a crushing machine for reducing the grain size of a bulk material, the comminuting machine comprising a machine housing (2) and at least one displacement apparatus (1), the machine housing (2) comprising at least one housing wall (3) with reinforcing ribs (14), which extend over at least some of the width of the at least one housing wall (3), or in the form of a slab, and the at least one displacement apparatus (1) being fastened to the at least one housing wall (3) and being movable into a displacement position, in which the comminuting machine can be displaced, standing on a support element (16) of the at least one displacement apparatus (1), and into a standing position, in which the comminuting machine stands in a stationary manner, wherein the at least one housing wall (3) has at least one cut-out formed for receiving the at least one displacement apparatus (1) so that the at least one displacement apparatus (1) can be integrated at least largely into the at least one housing wall (3), within the width thereof, by being arrangeable at least partially in the at least one cut-out.

2. A comminuting plant according to claim 1, wherein the at least one displacement apparatus (1) has a lifting apparatus, in particular a hydraulic cylinder (4), with at least portions of the comminuting machine being liftable with the lifting apparatus.

3. A comminuting plant according to claim 1, wherein the at least one displacement apparatus (1) has a pressure element (5) and a pressure element introduction opening (6), with the support element (16), the pressure element (5) and the pressure element introduction opening (6) being formed to support the at least one displacement apparatus (1) in relation to the housing wall (3) during displacement of the comminuting machine and to absorb at least a portion of the weight of the comminuting machine.

4. A comminuting plant according to claim 1, wherein the at least one displacement apparatus (1) has at least one wheel (17) and at least one wheel retainer.

5. A comminuting plant according to claim 1, wherein the at least one displacement apparatus (1) is designed for displacement on a rail (7) and comprises at least one rail guide (8), with the rail guide (8) being preferably forked to fit over the rail (7) on both sides.

6. A comminuting plant according to claim 1, wherein the at least one displacement apparatus (1) is rotatable about a substantially vertical axis (z), in particular by at least 90°, whereby a displacement direction (x, y) of the at least one displacement apparatus (1) can be defined, and, when the displacement direction (x, y) has been defined, an angular position of the at least one displacement apparatus (1) can be locked, preferably by means of a locking element (9).

7. A comminuting plant according to claim 1, wherein the comminuting plant comprises a load-bearing structure (10) comprising rails (7), whereby the comminuting machine can be displaced on the load-bearing structure (10).

8. A comminuting plant according to claim 1, wherein the comminuting plant comprises a turntable (11) which is rotatable about a pivot and has a rail segment (12) situated thereon.

9. A comminuting plant according to claim 8, wherein the rail segment (12) has a greater width in a central region of the turntable (11) than rails (7) next to the turntable (11) and preferably has a recess (13) for receiving the wheel (17).

10. A comminuting plant according to claim 5, wherein the at least one displacement apparatus (1) comprises a fork-like rail guide (8), which can fit over the rail segment (12) on both sides, so that the rail segment (12) remains engaged in the rail guide (8) when the at least one displacement apparatus (1) rotates, and the turntable (11) in engagement with the at least one displacement apparatus (1) can be rotated together with rotatable components of the at least one displacement apparatus (1).
